(19) United States
(12) Patent Application Publication
(10) Pub. No.: US 2011/0096085 A1
(43) Pub. Date: Apr. 28, 2011

(54) Apparatus and method determining image dynamic range extended mode using fuzzy rule

(75) Inventors: Joon Hyuk Cha, Incheon (KR); Young Su Moon, Seoul (KR); Shi Hwa Lee, Seoul (KR)

(73) Assignee: SAMSUNG ELECTRONICS CO., LTD., Suwon-si (KR)

(21) Appl. No.: 12/805,453

(22) Filed: Jul. 30, 2010

(30) Foreign Application Priority Data
Oct. 22, 2009 (KR) 10-2009-0100539

(51) Int. Cl. G09G 5/02

(52) U.S. Cl. 345/589

(57) ABSTRACT

Provided is an apparatus and method of determining a dynamic range extended mode for a digital camera using a fuzzy rule. The method may determine a feature value with respect to a preview image in accordance with a predetermined measurement criterion, and may determine a dynamic range extended mode using a fuzzy rule where the determined feature value is matched in the fuzzy rule, thereby intelligently controlling a photographing mode of the digital camera. In particular, the method may determine the feature value with respect to the preview image in accordance with various measurement criterions, thereby obtaining an optimum photographing mode for subsequent images.

### CROSS-REFERENCE TO RELATED APPLICATIONS

This application claims the benefit of Korean Patent Application No. 10-2009-0100539, filed on Oct. 22, 2009, in the Korean Intellectual Property Office, the disclosure of which is incorporated herein by reference.

### BACKGROUND

1. Field

One or more embodiments relate to a technology for determining a dynamic range extended mode of a digital camera using a fuzzy rule.

2. Description of the Related Art

When a high contrast image is photographed using a digital camera, details of the images may be deteriorated due to a limitation in a dynamic range of the digital camera. For example, when a dynamic range of light from a viewing area intended to be photographed is greater than that of the digital camera that captures the corresponding image of the viewing area, in ranges outside an exposure range of the digital camera, details of shadows and highlights of the viewing area may not be visible in the captured image. Thus, when the dynamic range for the viewing area is greater than an exposure range of a digital camera, a captured image of the viewing area may not reflect characteristics of the viewing area that fall within the extended range beyond the exposure range of the digital camera.

To overcome this problem, various methods of improving a contrast of images have been suggested. In this instance, a method of merely improving the contrast of images may improve the details within the images to some extent, but does not extend a dynamic range of captured images.

To extend the dynamic range for the captured image, methods of generating a relatively large image by a single piece of image using several pieces of image having been photographed and obtained using different exposure modes from each other have been suggested. However, when performing a thus necessary postprocess for extending the dynamic range, complexity in a photographing process or in the postprocess may increase, and the resultant images may become unnatural due to artificial contrast improvement. Accordingly, a picture obtained by unconditionally extending the dynamic range does not have superior image quality in comparison with an image photographed using an automatic exposure, for example.

Accordingly, determining whether extension in the dynamic range of the image may be desired, and determining a method by which an optimum resultant image is obtained, i.e., in the postprocess extending the dynamic range, has been attempted by advanced users.

### SUMMARY

An aspect of one or more embodiments provides an apparatus and method of determining a dynamic range extended mode of a digital camera using a fuzzy rule.

According to an aspect of one or more embodiments, there may be provided a method of determining a dynamic range extended mode for an image, the method including determining a feature value with respect to a preview image in accordance with a predetermined measurement criterion, and verifying whether a dynamic range of the preview image is extended based on the determined feature value applied to a fuzzy rule.

According to an aspect of one or more embodiments, there may be provided a method of determining a dynamic range extended mode for an image, the method including determining a feature value with respect to a preview image photographed using an automatic exposure mode, verifying whether a dynamic range of the preview image is extended by applying the determined feature value to a predetermined measurement criterion, and determining a photographing mode for the image based on the verified result.

According to an aspect of one or more embodiments, there may be provided an apparatus of determining a dynamic range extended mode for an image, the apparatus including a feature value determination unit to determine a feature value with respect to a preview image in accordance with various measurement criterions, and a fuzzy rule configuration unit to configure a fuzzy rule by mapping the determined feature value in the various measurement criterions.

According to one or more embodiments, it may be possible to intelligently control a photographing mode of the digital camera.

Also, according to one or more embodiments, it may be possible to obtain an optimum photographing mode.

Additional aspects, features, and/or advantages will be set forth in part in the description which follows and, in part, will be apparent from the description, or may be learned by practice of one or more embodiments presented in the disclosure.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 is a flowchart illustrating a method of determining a dynamic range extended mode for an image, according to one or more embodiments;

FIG. 2 illustrates histograms with respect to images, according to one or more embodiments;

FIG. 3 illustrates a distribution range of an average luminance used in a second measurement criterion, according to one or more embodiments;

FIG. 4 illustrates a number of pixels for each range of a luminance histogram used in a fourth measurement criterion, according to one or more embodiments;

FIG. 5 illustrates a fuzzy rule configured to verify a dynamic range extended mode, according to one or more embodiments; and

FIG. 6 is a block diagram illustrating an apparatus determining a dynamic range extended mode, according to one or more embodiments.

### DETAILED DESCRIPTION

Reference will now be made in detail to embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

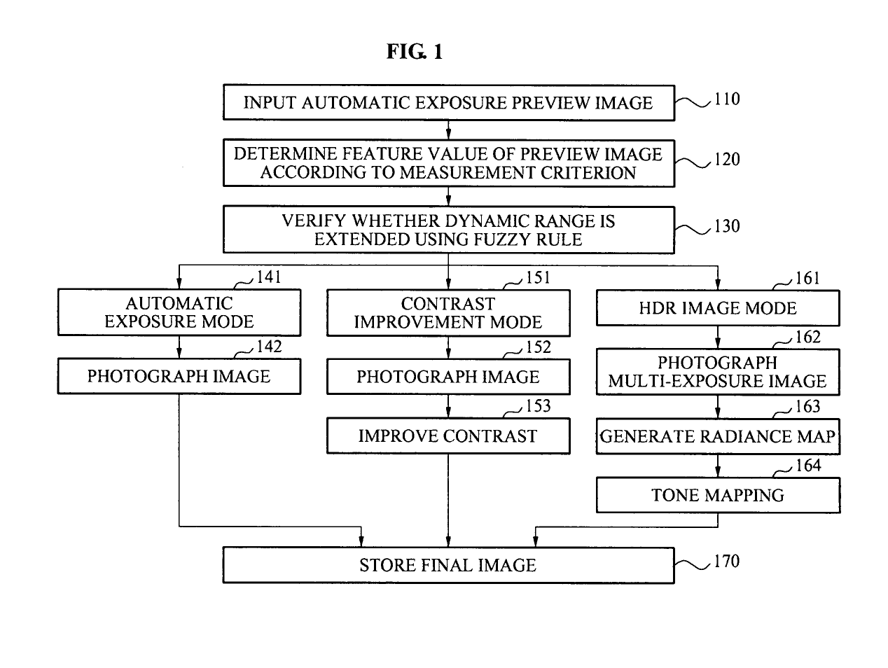

FIG. 1 is a flowchart illustrating a method of determining a dynamic range extended mode, according to one or more embodiments.

Referring to FIG. 1, in operation 110, a preview image photographed through automatic exposure may be input. In one or more embodiments, the preview image may be an image captured before a current setting of a dynamic range extending mode, e.g., for subsequent captured images, with an appropriate dynamic range extending mode being automatically selected and/or automatically applied.

In operation 120, a feature value may be determined with respect to the preview image in accordance with a predetermined measurement criterion.

In general, when a dynamic range of light from a viewing area intended to be photographed is greater than that of a digital camera, available a details of a corresponding captured image may be deteriorated due to the limitation in the dynamic range of the digital camera.

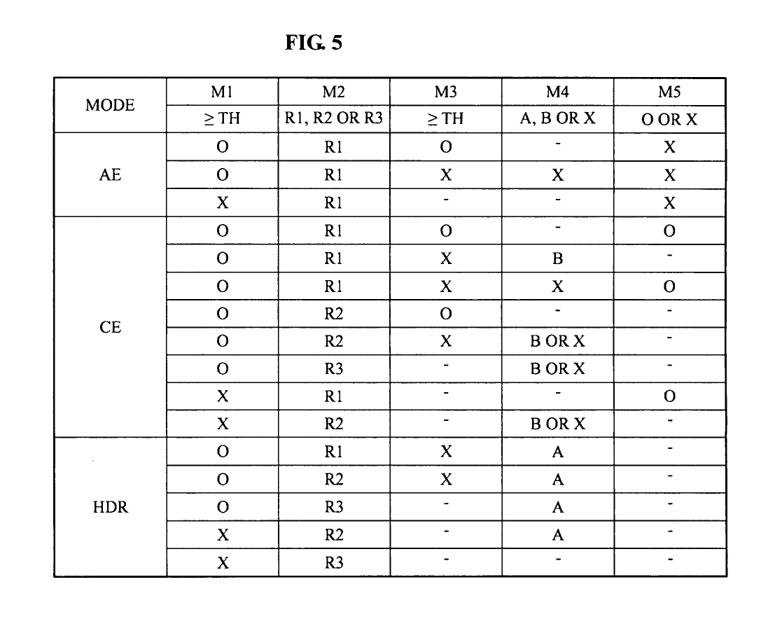

To minimize the deterioration of the image, in operation 130, a verification may be made as to whether the dynamic range of the preview image is extended using a fuzzy rule, e.g., selecting a desired photographing mode to apply based on the determined feature value matching the fuzzy rule, such as the fuzzy rule shown in FIG. 5.

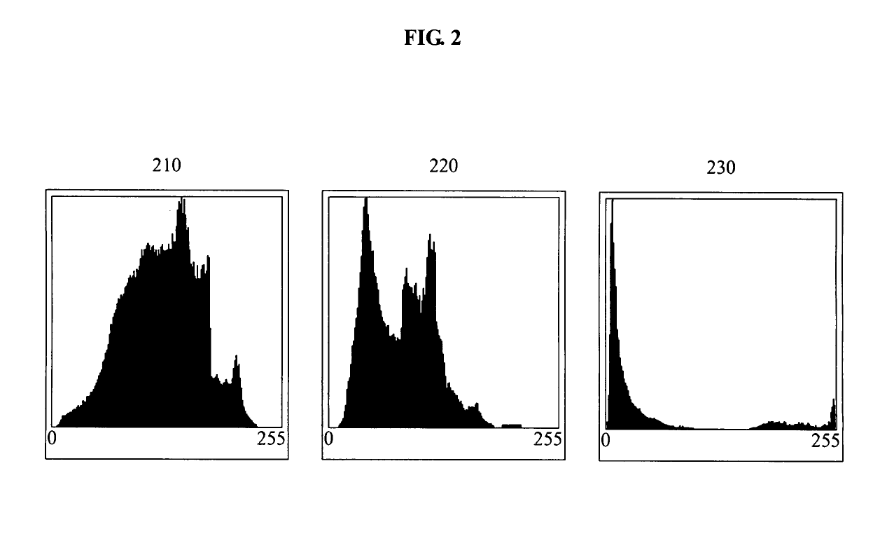

FIG. 2 illustrates histograms with respect to images, according to one or more embodiments. The histograms represent frequencies on the Y axis and luminance intensity on the X axis.

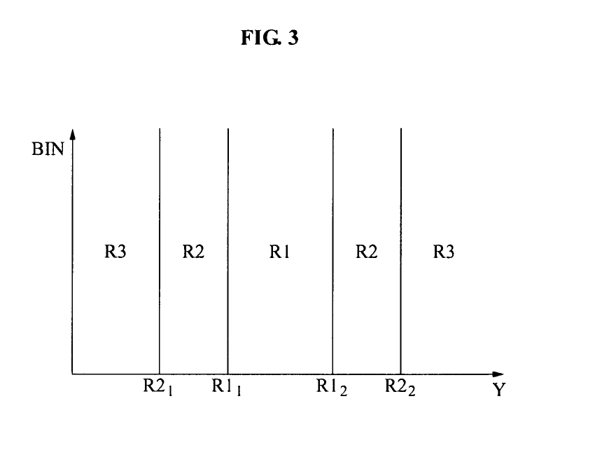

Referring to FIG. 2, in an automatic exposure mode 210 in which the dynamic range of the image is appropriately distributed, an average luminance value for pixels of an image is generally located in the illustrated luminance intensity region ‘R1’ of FIG. 3, e.g., the luminance of pixels is densely or evenly distributed more in a middle luminance intensity portion of a corresponding histogram.

Unlike this, in a contrast improvement mode 220, multi-exposure image matching used for extension of the dynamic range may not be necessary, however, an average luminance value for pixels of the image is located in the illustrated luminance intensity region ‘R2’ of FIG. 3. Here, a luminance of pixels may be more densely distributed in a shadow or less luminance intense area of a corresponding histogram, and thereby a contrast extension mode may be needed.

However, in a high dynamic range (HDR) image mode 230 showing a significantly high contrast, a brightness of pixels of the image is more densely distributed in the lowest intensity area and the highest intensity area of a corresponding histogram. Here, details of a highlight, e.g., higher intense feature, and shadow of the image may be deteriorated.

Accordingly, the present inventors have found that a method of determining the dynamic range extended mode may desirably to be performed by verifying cases where an appropriate exposure should be provided with respect to the preview image, using various measurement criterions, and by combining the verified results using a fuzzy logic method, that is, the fuzzy logic rule.

According to one or more embodiments, the method may define five measurement criterions as follows, noting that additional and/or alternative measurement criterions would also be available.

First Measurement Criterion (M1)

A first measurement criterion may be defined based on a normalized standard deviation of the preview image having a maximum value, from among a normalized standard deviation of a red (R) channel, a normalized standard deviation of a green (G) channel, and a normalized standard deviation of a blue (B) channel.

According to an embodiment, it may be verified whether the normalized standard deviation having the maximum value is greater than a predetermined first threshold, and the first measurement criterion may be defined based on the normalized standard deviation being greater than the first threshold to thereby determine the feature value with respect to the preview image.

As only an example, in an embodiment, the above described normalized standard deviation of the R channel may be obtained using the following Equation 1.

$${Var}_{R} = \frac{1}{256} \sqrt{\frac{1}{N} {\sum }_{i = 0}^{255} {( i \times {R}_{h} ( i ) - {m}_{R} )}^{2}} \qquad Equation 1$$

Here, Var_{R} denotes the normalized standard deviation of the R channel, N denotes a total number of pixels, Rₕ(i) denotes a number of Bins of a histogram of the R channel, and m_{R} denotes an average of the R channel. Briefly, a Bin is a representative of a frequency range, and the number of Bins could represent the number of separate ranges a select entire range of frequencies may be divided into. Thus, in an embodiment, the normalized standard deviation Var_{G} of the G channel and the normalized standard deviation Var_{B} of the B channel may similarly be obtained based on Equation 1. Also, the first measurement criterion may be further obtained using the following Equation 2, for example.

$$M 1 = \{ \begin{matrix}O , & if max ( {Var}_{R} , {Var}_{G} , {Var}_{B} ) \geq {TH}_{M 1} \\ X , & otherwise\end{matrix} \qquad Equation 2$$

Here, M1 denotes the first measurement criterion, Var_{R} denotes the normalized standard deviation of the R channel, Var_{G} denotes the normalized standard deviation of the G channel, Var_{B} denotes the normalized standard deviation, and TH_{M1} denotes the predetermined first threshold. Accordingly, the feature value may be a representation of whether the normalized standard deviation having the maximum value is greater than the first threshold. As an example, as shown in FIG. 5, the fuzzy rule for the first measurement criterion may represent the normalized standard deviation being equal to or greater than the first threshold with a ‘O’, and represent the normalized standard deviation being less than the first threshold with an ‘X’.

Second Measurement Criterion (M2)

The method may define a second measurement criterion based on a distribution range of an average luminance for the preview image.

According to an embodiment, an average luminance of the preview image may be calculated, and the second measurement criterion may be defined based on the calculated average luminance to thereby determine the feature value with respect to the preview image. Here, the above described average luminance may be obtained using the following Equation 3, for example.

$${Y}_{mean} = \frac{1}{N} {\sum }_{i = 0}^{N} ( 0.29 \times R ( i ) + 0.59 \times G ( i ) + 0.12 \times B ( i ) ) \qquad Equation 3$$

Here, Yₘₑₐₙ denotes the average luminance, N denotes a total number of pixels, R(i) denotes a value of a red color of an i-th pixel, G(i) denotes a value of a green color of the i-th pixel, and B(i) denotes a value of a blue color of the i-th pixel of the preview image.

The second measurement criterion may be further obtained using the following Equation 4, for example.

$$M 2 = \{ \begin{matrix}R 1 , & if R {1}_{1} \leq {Y}_{mean} \leq R {1}_{2} \\ R 2 , & if R {2}_{1} \leq {Y}_{mean} \leq R {1}_{1} or R {1}_{2} \leq {Y}_{mean} \leq R {2}_{2} \\ R 3 , & otherwise\end{matrix} ,$$

Here, M2 denotes the second measurement criterion as one of R1, R2, and R3, such as represented in the fuzzy rule of FIG. 5, and each of R1₁, R1₂, R2₁, and R2₂ denote predetermined interval average luminance intensity ranges.

FIG. 3 illustrates a distribution range of an average luminance intensity used in a second measurement criterion, according to one or more embodiments.

Referring to FIG. 3, when the average luminance (Y) is included in a range of R1₁ to R1₂, the method may determine as the second measurement criterion the feature value to be ‘R1’, when the average luminance (Y) is included in a range of R2₁ to R1₁; the feature value may be determined to be ‘R2’, when included in a range of R1₂ to R2₂; and the feature value may be determined to be ‘R3’ when the average luminance (Y) is not included in these R2₁ to R1₁ or R1₂ to R2₂ ranges. Additional and/or alternative ranges are equally available.

Third Measurement Criterion (M3)

The method may define, as a third measurement criterion, a relative average of a number of luminance histogram Bins for the preview image.

According to an embodiment, the method may verify whether the relative average of a number of luminance histogram Bins is greater than a predetermined third threshold, and define, as the third measurement criterion, the relative average of the number of luminance histogram Bins being greater than the third threshold to thereby determine the feature value with respect to the preview image in accordance with the defined third measurement criterion. Here, the relative average of the number of luminance histogram Bins may be obtained using the following Equation 5, for example.

$${Y}_{rei} = \frac{1}{256} {\sum }_{i = 0}^{255} ( \frac{{Y}_{k} ( i )}{{Y}_{max}} )$$

Here, Yᵣₑₗ denotes the relative average of the number of luminance histogram Bins, Yₕ(i) denotes a number of i-th Bins of a luminance histogram, and Yₘₐₓ denotes a maximum number of Bins. The third measurement criterion may be further obtained using the following Equation 6, for example.

$$M 3 = \{ \begin{matrix}O , & if {Y}_{rel} \geq {TH}_{M 3} \\ X , & otherwise\end{matrix}$$

Here, M3 denotes the third measurement criterion, and TH_{M3} denotes the predetermined third threshold. Here, a feature value may be a representation of whether the obtained relative average of the number of luminance histogram Bins is greater than or equal to the third threshold. As an example, as shown in FIG. 5, the fuzzy rule for the third measurement criterion may represent the relative average of the number of luminance histogram Bins being greater than or equal to the third threshold with a ‘O’, and represent the relative average of the number of luminance histogram Bins being less than the third threshold with an ‘X’.

Fourth Measurement Criterion (M4)

The method may define, as a fourth measurement criterion, a number of pixels for each range of a luminance histogram for the preview image.

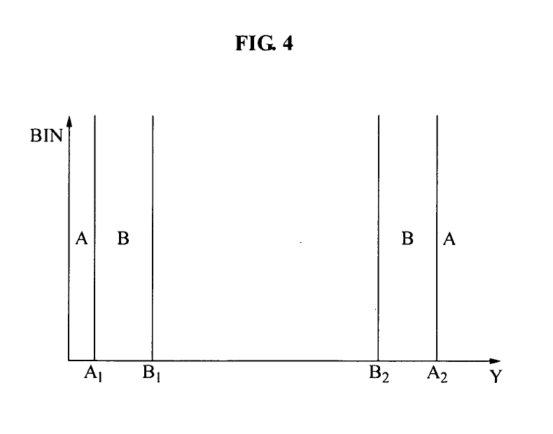

FIG. 4 illustrates a number of pixels for each range of a luminance histogram used in a fourth measurement criterion, according to one or more embodiments.

Referring to FIG. 4, it may be verified whether a number of pixels of the preview image distributed in respective predetermined ranges ‘A’ and ‘B’ of a luminance histogram is greater than a fourth threshold, and define the fourth measurement criterion based on the verified result to thereby determine the feature value with respect to the preview image in accordance with the defined fourth measurement criterion.

As only an example, when a number of pixels distributed in ranges A₁ and A₂, e.g., corresponding to the lowest and highest ranges, of the histogram is greater than or equal to the fourth threshold, the method may determine the feature value ‘A’ for representing in the fuzzy rule of FIG. 5, and when the number of pixels in ranges A₁ and A₂ is smaller than the fourth threshold and a number of pixels distributed in ranges B₁ and B₂ is greater than or equal to the fourth threshold, the method may determine the feature value to be ‘B’ for representing in the fuzzy rule of FIG. 5. Further, when the number of pixels in ranges B₁ and B₂ is smaller than the fourth threshold, the feature value may be set to ‘X’ for representing in the fuzzy rule of FIG. 5.

Fifth Measurement Criterion (M5)

The method may define, as a fifth measurement criterion, whether a blank pixel, e.g., a lack of pixels representing a sufficiently low number of pixels, exist within an interval having a predetermined standard size in each of histograms of the R channel, the G channel, and the B channel for the preview image.

According to an embodiment, it may be verified whether the blank pixel exists (lack of pixels) within a predetermined interval, e.g., by determining whether the number of pixels existing within the interval is smaller than a fifth threshold for each of the R channel, the G channel, and the B channel, and define the fifth measurement criterion based on the verified result to thereby determine the feature value with respect to the preview image in accordance with the defined fifth measurement criterion. Here, as an example, a number of pixels existing within an interval having a predetermined standard size in the histogram of the R channel may be obtained using the following Equation 7.

$${R}_{Range} ( i ) = {\sum }_{i = 0}^{255 - {R}_{M 5}} ( {\sum }_{j = 1}^{i + {R}_{M 5}} {R}_{h} ( j ) ) \qquad Equation 7$$

Here, Range(i) denotes the number of pixels existing within the interval having the predetermined standard size in the histogram of the R channel, Rm5 denotes the predetermined standard size, and Rₕ(j) denotes the histogram of the R channel. In this manner, G_{range}(i) and B_{range}(i) may similarly be obtained from the histograms Gₕ(j) and Bₕ(j) of the respective G and B channels based on Equation 7. The fifth measurement criterion may be further obtained using the following Equation 8, for example.

$$M 5 = \{ \begin{matrix}O , & if {R}_{range} ( i ) \geq {TH}_{M 5} or {G}_{range} ( i ) \geq {TH}_{M 5} or {B}_{range} ( i ) \geq {TH}_{M 5} \\ X , & otherwise\end{matrix} \qquad Equation 8$$

Here, M5 denotes the fifth measurement criterion, and TH_{M5} denotes the fifth threshold. Accordingly, a feature value may be a representation of whether the number of pixels existing within the interval having the predetermined standard size in each of histograms of the R channel, the G channel, and the B channel is greater than or equal to the fifth threshold, e.g., representative of whether the number of pixels existing within the interval is sufficiently low for each of the R channel, the G channel, and the B channel. As an example, as shown in FIG. 5, the fuzzy rule for the fifth measurement criterion may represent the number of pixels existing within the interval for any of the R, G, and B channels being greater than or equal to the fifth threshold with a ‘O’, and represent the number of pixels existing within the interval for all R, G, and B channels being less than the fifth threshold with an ‘X’.

In this manner, the method may configure the fuzzy rule, which will be described in detail with further reference to FIG. 5.

FIG. 5 illustrates a fuzzy rule configured to verify a dynamic range extended mode, according to one or more embodiments.

Referring to FIG. 5, the method may verify a photographing mode, for the capturing of images, such as an automatic exposure mode (hereinafter, referred to as ‘AE’), a contrast improvement mode (hereinafter, referred to as ‘CE’), and an HDR image mode (hereinafter, referred to as ‘HDR’), where the feature value of the preview image corresponds to, thereby determining whether the dynamic range of the digital camera is extended.

For example, the method may determine the photographing mode as one of the AE, the CE, and the HDR modes represented in FIG. 5 depending on whether/how the dynamic range is extended.

When the photographing mode is determined to be the AE mode, images may be photographed next or processed using the AE mode, which corresponds to operations 141 and 142 of FIG. 1.

When the photographing mode is determined as the CE mode, images may be photographed next or processed using the CE mode to improve a contrast of the images, which corresponds to operations 151, 152, and 153 of FIG. 1.

When the photographing mode is determined as the HDR mode, images may be photographed next or processed using the HDR mode to generate a radiance map and to perform a tone mapping, which corresponds to operations 161, 162, 163, and 164 of FIG. 1.

Finally, in operation 170, the method may store the images photographed using the determined photographing mode.

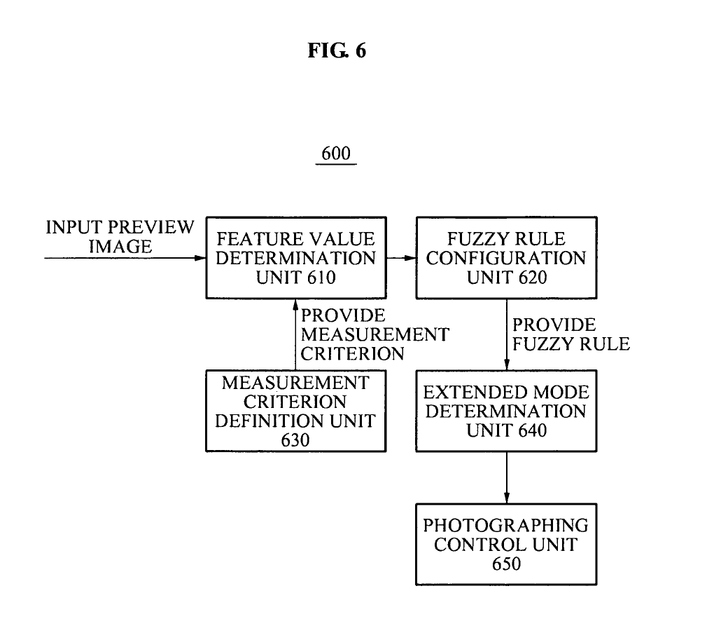

FIG. 6 is a block diagram illustrating an apparatus 600 determining a dynamic range extended mode, according to one or more embodiments.

Referring to FIG. 6, the apparatus 600 includes a feature value determination unit 610, a fuzzy rule configuration unit 620, a measurement criterion definition unit 630, an extended mode verification unit 640, and a photographing control unit 650, for example.

The feature value determination unit 610 may determine a feature value with respect to a preview image in accordance with various measurement criterions.

To define the various measurement criterions, the measurement criterion definition unit 630 may define the measurement criterion as any one of (1) a normalized standard deviation having a maximum value from among a normalized standard deviation of an R channel, a normalized standard deviation of a G channel, and a normalized standard deviation of a B channel, (2) a distribution range of an average luminance, (3) a relative average of a number of Bins of a luminance histogram, (4) a number of pixels for each range of the luminance histogram, and (5) whether a lack of pixels exists within an interval having a predetermined standard size in each of histograms of the R channel, the G channel, and the B channel.

In this case, the feature value determination unit 610 may determine the feature value with respect to the preview image in accordance with the above defined measurement criterion.

The fuzzy rule configuration unit 620 may configure a fuzzy rule by mapping the determined feature value in the various measurement criterions. The fuzzy rule configuration unit 620 may configure the fuzzy rule including the feature value corresponding to the various measurement criterions, as illustrated in FIG. 5.

The extended mode verification unit 640 may verify whether the dynamic range is extended using the configured fuzzy rule.

The photographing control unit 650 may determine a photographing mode based on the verified result, and may control to photograph images in accordance with the determined photographing mode. For example, the photographing control unit 650 may determine the photographing mode as one of the AE, the CE, and the HDR modes.

Descriptions of FIGS. 1 to 5 may be applicable in the apparatus 600, and thus detailed descriptions thereof will be omitted. In addition, the apparatus 600 may include one or more hardware processing elements. For example, each described unit may include one or more processing elements, desirable memory, and any desired hardware input/output transmission devices. Further, the term apparatus should be considered synonymous with elements of a physical system, not limited to a single enclosure or all described elements embodied in single respective enclosures in all embodiments, but rather, depending on embodiment, is open to being embodied together or separately in differing enclosures and/or locations through differing hardware elements.

One or more embodiments may include a computer-readable storage medium including computer readable instructions to control a least one processing device to implement a determining of a dynamic range extended mode for an image. The computer readable instructions may, thus, be recorded, stored, or fixed in one or more non-transitory computer-readable storage media including computer readable instructions to be implemented by the at least one processing device, such as a computer, to cause the at least one processing device to execute or perform the computer readable instructions. The media may also include data files, data structures, and the like. The media and computer readable instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network device, so that the computer readable instructions are stored and executed in a distributed fashion. The computer readable instructions may be executed by one or more processors. The computer-readable media may also be embodied in at least one application specific integrated circuit (ASIC) or Field Programmable Gate Array (FPGA), which executes (processes like a processor) computer readable instructions. Examples of computer readable instructions include both machine code, such as produced by a compiler, and files containing higher level code that may be executed by the computer using an interpreter.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A method of determining a dynamic range extended mode for an image, the method comprising:
determining a feature value with respect to a preview image in accordance with a predetermined measurement criterion; and
verifying whether a dynamic range of the preview image is extended based on the determined feature value applied to a fuzzy rule.

2. The method of claim 1, wherein the determining of the feature value comprises:
verifying whether a normalized standard deviation having a maximum value, from among a normalized standard deviation of a red (R) channel, a normalized standard deviation of a green (G) channel, and a normalized standard deviation of a blue (B) channel of the preview image, is greater than a predetermined first threshold;
defining a first measurement criterion based on the verifying of whether the normalized standard deviation is greater than the predetermined first threshold; and
determining the feature value with respect to the preview image in accordance with the first measurement criterion.

3. The method of claim 2, wherein the normalized standard deviation of each of the R channel, the G channel, and the B channel is obtained based on the following:
$${Var}_{R} = \frac{1}{256} \sqrt{\frac{1}{N} {\sum }_{i = 0}^{255} {( i \times {R}_{h} ( i ) - {m}_{R} )}^{2}} ,$$
where Var_{R} denotes the normalized standard deviation of the R channel, N denotes a total number of pixels, Rₕ(i) denotes a number of Bins of a histogram of the R channel, and m_{R} denotes an average of the R channel, and the first measurement criterion is obtained based on the following:
$$M 1 = \{ \begin{matrix}O , & if max ( {Var}_{R} , {Var}_{G} , {Var}_{B} ) \geq {TH}_{M 1} \\ X , & otherwise\end{matrix} ,$$
where M1 denotes the first measurement criterion for the fuzzy rule, Var_{R} denotes the normalized standard deviation of the R channel, Var_{G} denotes a normalized standard deviation of the G channel, Var_{B} denotes a normalized standard deviation, and TH_{M1} denotes the predetermined first threshold.

4. The method of claim 1, wherein the determining of the feature value comprises:
calculating an average luminance of the preview image;
defining a second measurement criterion based on a distribution range of the calculated average luminance; and
determining the feature value with respect to the preview image in accordance with the defined second measurement criterion.

5. The method of claim 4, wherein the average luminance is obtained based on the following:
$${Y}_{mean} = \frac{1}{N} {\sum }_{i = 0}^{N} ( 0.29 \times R ( i ) + 0.59 \times G ( i ) + 0.12 \times B ( i ) ) ,$$
where Yₘₑₐₙ denotes the average luminance, N denotes a total number of pixels, R(i) denotes a value of a red color of an i-th pixel, G(i) denotes a value of a green color of the i-th pixel, and B(i) denotes a value of a blue color of the i-th pixel, and the second measurement criterion is obtained based on the following:
$$M 2 = \{ \begin{matrix}R 1 , & if R {1}_{1} \leq {Y}_{mean} \leq R {1}_{2} \\ R 2 , & if R {2}_{1} \leq {Y}_{mean} \leq R {1}_{1} or R {1}_{2} \leq {Y}_{mean} \leq R {2}_{2} \\ R 3 , & otherwise\end{matrix} ,$$
where M2 denotes the second measurement criterion, each of R1, R2, and R3 denotes the distribution ranges of the fuzzy rule, and each of R1₁, R1₂, R2₁, and R2₂ denotes a predetermined interval range.

6. The method of claim 1, wherein the determining of the feature value comprises:
verifying whether a relative average of a number of luminance histogram Bins of the preview image is greater than a predetermined third threshold;
defining a third measurement criterion based on the relative average of the number of luminance histogram Bins being greater than the predetermined third threshold; and
determining the feature value with respect to the preview image in accordance with the defined third measurement criterion.

7. The method of claim 6, wherein the relative average of the number of luminance histogram Bins is obtained based on the following:
$${Y}_{rel} = \frac{1}{256} {\sum }_{i = 0}^{255} ( \frac{{Y}_{h} ( i )}{{Y}_{max}} ) ,$$
where Yᵣₑₗ denotes the relative average of the number of luminance histogram Bins, Yₕ(i) denotes a number of i-th Bins of a luminance histogram, and Yₘₐₓ denotes a maximum number of Bins, and the third measurement criterion is obtained based on the following:
$$M 3 = \{ \begin{matrix}O , & if {Y}_{rel} \geq {TH}_{M 3} \\ X , & otherwise\end{matrix} ,$$
where M3 denotes the third measurement criterion, and TH_{M3} denotes the predetermined third threshold.

8. The method of claim 1, wherein the determining of the feature value comprises:
verifying whether a number of pixels distributed in a predetermined range in a luminance histogram of the preview image is greater than a fourth threshold;
defining a fourth measurement criterion based on a result of the verifying of the number of pixels being greater than the fourth threshold; and
determining the feature value with respect to the preview image in accordance with the defined fourth measurement criterion.

9. The method of claim 1, wherein the determining of the feature value comprises:
verifying whether a number of pixels existing within an interval having a predetermined standard size in each of histograms of an R channel, a G channel, and a B channel of the preview image is greater than a fifth threshold;
defining a fifth measurement criterion based on a result of the verifying of the number of pixels being greater than the fifth threshold; and
determining the feature value with respect to the preview image in accordance with the defined fifth measurement criterion.

10. The method of claim 9, wherein the number of pixels existing within the interval having the predetermined criterion size is obtained based on the following:
$${R}_{Range} ( i ) = {\sum }_{i = 0}^{255 - {R}_{M 5}} ( {\sum }_{j = 1}^{i + {R}_{M 5}} {R}_{h} ( j ) ) ,$$
where R_{Range}(i) denotes the number of pixels existing within the interval having the predetermined standard size in the histogram of the R channel, Rₘ₅ denotes the predetermined standard size, and Rₕ(j) denotes the histogram of the R channel, and the fifth measurement criterion is obtained based on the following:
$$M 5 = \{ \begin{matrix}O , & if {R}_{range} ( i ) \geq {TH}_{M 5} or {G}_{range} ( i ) \geq {TH}_{M 5} or {B}_{range} ( i ) \geq {TH}_{M 5} \\ X , & otherwise\end{matrix} ,$$
where M5 denotes the fifth measurement criterion, and TH_{M5} denotes the fifth threshold.

11. The method of claim 1, wherein the verifying of whether the dynamic range is extended comprises:
determining a photographing mode for the image as one of an automatic exposure mode, a contrast improvement mode, and a high dynamic range (HDR) image mode depending on whether the dynamic range is determined to be extended.

12. A method of determining a dynamic range extended mode for an image, the method comprising:
determining a feature value with respect to a preview image photographed using an automatic exposure mode;
verifying whether a dynamic range of the preview image is extended by applying the determined feature value to a predetermined measurement criterion; and
determining a photographing mode for the image based on the verified result.

13. The method of claim 12, wherein the predetermined measurement criterion is any one of (1) a normalized standard deviation having a maximum value from among a normalized standard deviation of an R channel, a normalized standard deviation of a G channel, and a normalized standard deviation of a B channel, (2) a distribution range of an average luminance, (3) a relative average of a number of Bins of a luminance histogram, (4) a number of pixels for each range of the luminance histogram, and (5) whether a lack of pixels exists within an interval having a predetermined standard size in each of histograms of the R channel, the G channel, and the B channel.

14. The method of claim 12, wherein the determining of whether the dynamic range is extended comprises:
configuring a fuzzy rule by mapping the determined feature value in the predetermined measurement criterion; and
verifying whether the dynamic range is extended using the configured fuzzy rule.

15. At least one non-transitory medium comprising computer readable instructions to control at least one processing device to implement the method of claim 1.

16. An apparatus of determining a dynamic range extended mode for an image, the apparatus comprising:
a feature value determination unit to determine a feature value with respect to a preview image in accordance with various measurement criterions; and
a fuzzy rule configuration unit to configure a fuzzy rule by mapping the determined feature value in the various measurement criterions.

17. The apparatus of claim 16, further comprising:
an extended mode verification unit to verify whether the dynamic range of the preview image is extended using the configured fuzzy rule; and
a photographing control unit to determine a photographing mode for the image based on the verified result, and to control to photograph images subsequent to the preview image in accordance with the determined photographing mode.

18. The apparatus of claim 17, wherein the photographing control unit determines the photographing mode as any one of an automatic exposure mode, a contrast improvement mode, and an HDR image mode, based on the verification of whether the dynamic range is extended.

19. The apparatus of claim 16, further comprising:
a measurement criterion definition unit to define a measurement criterion, of the various measurement criterions, as any one of (1) a normalized standard deviation having a maximum value from among a normalized standard deviation of an R channel, a normalized standard deviation of a G channel, and a normalized standard deviation of a B channel, (2) a distribution range of an average luminance, (3) a relative average of a number of Bins of a luminance histogram, (4) a number of pixels for each range of the luminance histogram, and (5) whether a lack of pixels exists within an interval having a predetermined standard size in each of histograms of the R channel, the G channel, and the B channel, wherein
the feature value determination unit determines the feature value with respect to the preview image in accordance with the defined measurement criterion.
